(19) United States
(12) Patent Application Publication
(10) Pub. No.: US 2009/0083225 A1
(43) Pub. Date: Mar. 26, 2009

(54) ADVERTISEMENT FILTERING AND TARGETING THROUGH USER-PREFERENCES

(75) Inventors: Philip Jacobs, Windham, NH (US); James Randolph Sisk, Austin, TX (US)

Correspondence Address: BAINWOOD HUANG & ASSOCIATES LLC, 2 CONNECTOR ROAD, WESTBOROUGH, MA, 01581, US

(73) Assignee: CISCO TECHNOLOGY, INC., San Jose, CA (US)

(21) Appl. No.: 11/861,513

(22) Filed: Sep. 26, 2007

(51) Int. Cl. G06F 17/30

(52) U.S. Cl. 707/3; 707/E17.014

(57) ABSTRACT

A method is provided. The method includes (a) querying a viewer for a preference setting for provision of advertisements, (b) receiving from the viewer a response to the query for the preference setting for provision of advertisements, and (c) providing to the viewer an electronic signal, the electronic signal including (i) a first component having a main content portion, and (ii) a second component having advertisements in accordance with the received selection of advertisement preferences. The first component and the second component are distinct. Software and apparatus embodiments are provided as well.

### TECHNICAL FIELD

The present disclosure relates generally to advertising selection.

### BACKGROUND

Viewers of advertisements (e.g., banners ads on web pages, commercials on television, video advertisements presented before or during main video presentations) often do not pay attention to the advertisements because the advertisements are too numerous and are of insufficient relevance to the viewer. In addition, the prevalence of video recording devices allows viewers to fast-forward through video advertisements. Similarly, the prevalence of ad-blocking software allows viewers to view web pages without seeing the banner ads.

Various schemes have been used to encourage viewers to view advertisements. In one technique, a web site collects information about the products previously bought by a user, and targets banner advertisements to that user based on the types of products that the user has purchased. In another technique, a web site collects information about the web pages viewed by the user, and targets banner advertisements to that user based on the types of web pages that the user has viewed. In another technique, a web site presents a user with banner advertisements based on search query terms entered by the user for a web search. In another technique, a user watches a movie, but advertising before or during the movie is presented in a mode that prevents the user from fast-forwarding through the advertisements.

### BRIEF DESCRIPTION OF THE DRAWINGS

Objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 illustrates an example system for use in practicing one embodiment.

FIG. 2 illustrates an example video timeline that may be produced by one embodiment.

FIG. 3 illustrates an example web page as displayed on a display screen in one embodiment.

FIG. 4 illustrates an example Graphical User Interface of one embodiment.

FIG. 5 illustrates a method employed by one embodiment.

### DETAILED DESCRIPTION

### Overview

Provided is a description of various embodiments which provide for improved method, computer program product, and apparatus for advertisement filtering. In these embodiments, a viewer is given more control over the advertising that he or she sees.

One embodiment is directed toward a method in which a viewer is queried for a preference setting for provision of advertisements, the viewer responds to the query with a preference setting for provision of advertisements, and advertising is provided to the viewer in accordance with the received preference setting, together with main content.

Other embodiments are directed to a computer program product and to an apparatus which perform a similar method.

### DESCRIPTION OF EXAMPLE EMBODIMENTS

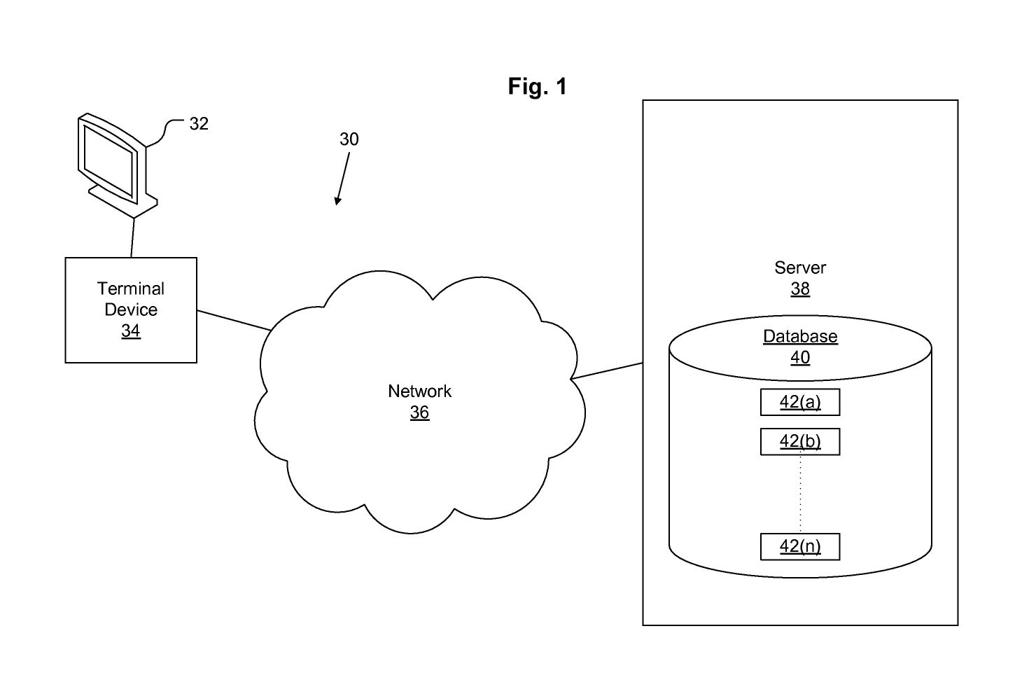

FIG. 1 illustrates an example system 30 over which embodiments may be practiced. A viewer views a display device 32, which is connected to a terminal device 34. The terminal device 34 connects to a network 36, which in turn connects to a server 38. The server 38 contains a database 40, storing information about a set of advertisements 42(a), 42(b), . . . , 42(n) (generally, advertisements 42).

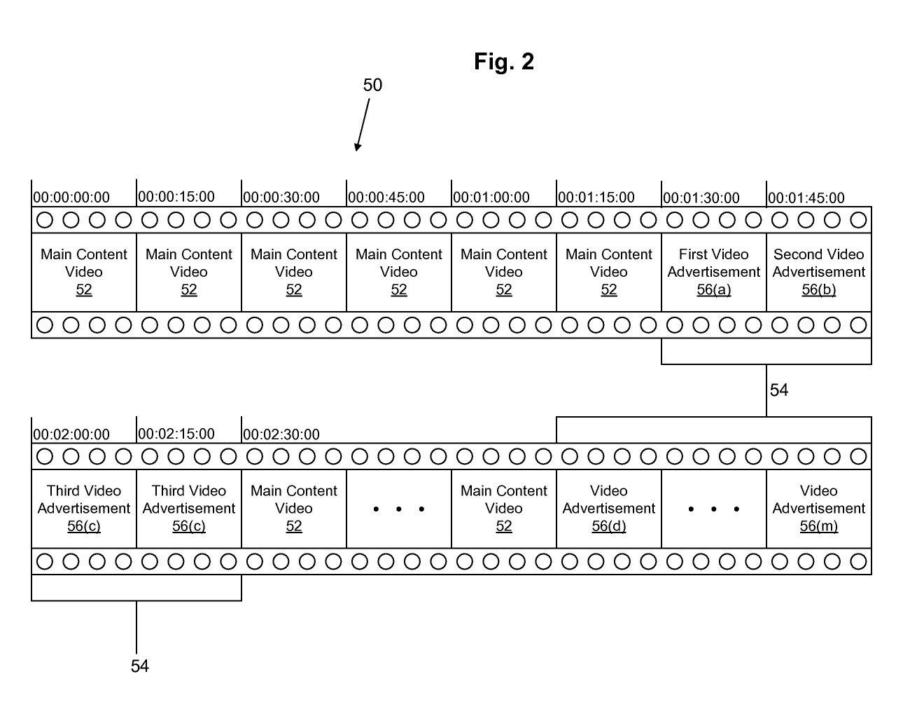

In one embodiment, represented in FIG. 2, the advertisements 42 are pre-recorded video advertisements. A timeline 50 represents a stream of video to be displayed on the display device 32. At time index 00:00:00:00 (representing 0 hours, 0 minutes, 0 seconds, and 0 frames into the video stream), main content video 52 is delivered to the viewer. This main content video 52 may be, for example, a television show or a movie, but it may not be an advertisement. This main content video 52 remains displayed for an interval of time. At some point (as depicted in FIG. 2, time index 00:01:30:00), the main content video is replaced with video advertising 54. The video advertising 54 may be composed of one or more video advertisements 56(a), 56(b), . . . , 56(m) (generally video advertisements 56). As depicted three video advertisements 56 are shown before main content video 52 resumes. First video advertisement 56(a) is displayed on screen for 15 seconds, second video advertisement 56(b) is displayed on screen for 15 seconds, and third video advertisement 56(c) is displayed on screen for 30 seconds. Thus, main content video 52 resumes at time index 00:02:30:00, after which periods of main content video 52 and video advertising 54 may alternate.

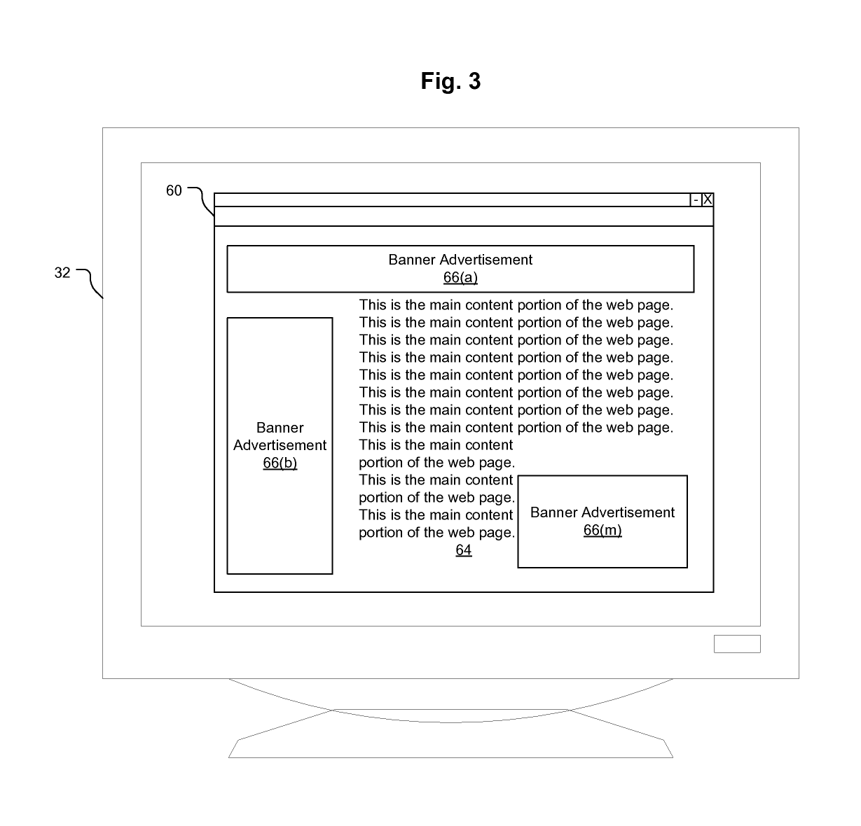

In another embodiment, represented in FIG. 3, the advertisements 42 are banner advertisements for display on web pages. The display device 32 displays a window 60, containing a web page 62. The web page 62 contains a main content portion 64, as well as an advertising portion 66. The advertising portion is made up of one or more banner advertisements 66(a), 66(b), . . . , 66(m). This main content portion 64 may contain any content normally found on a web page, but it does not include any advertisements.

In another embodiment, the advertisements 42 are shown on a first web page displayed to the viewer. This first web page generally does not have any main content. After the viewer has seen the advertisements on the first web page, the viewer is then permitted to see a second web page containing the main content.

In general, the term “main content” refers to any content, excluding advertising, which provides value to a viewer. Thus, on a web page containing review of cars, the car reviews are part of the main content. However, advertisements presented on that same page, paid for by a car manufacturer or a car dealer, would qualify as advertisements rather than as main content. It should be noted, however, that in rare cases content which might otherwise be classified as an advertisement could be considered to be main content, but only if specifically requested by a viewer. For example, a viewer wishes to see video clips of the television commercials presented during the 2007 Superbowl, because the viewer wishes to decide which advertisement was the best one presented. Thus, a viewer may visit a web site devoted to displaying video clips of such advertisements, and the viewer may request to see a particular video clip of such an advertisement. In such a (rare) case, the video clip of the requested advertisement is to be considered main content.

An “advertisement” is defined to be a promotion of a good, service, or company. The advertisement must be paid for by the company or a seller of such good or service.

In one embodiment, the terminal device 34 is a computer. In another embodiment, the terminal device 34 is a set-top box for a cable television system. In either case, the terminal device 34 may run software to perform the methods described below.

In one embodiment, the display device 32 is a computer monitor. In another embodiment, the display device 32 is a television.

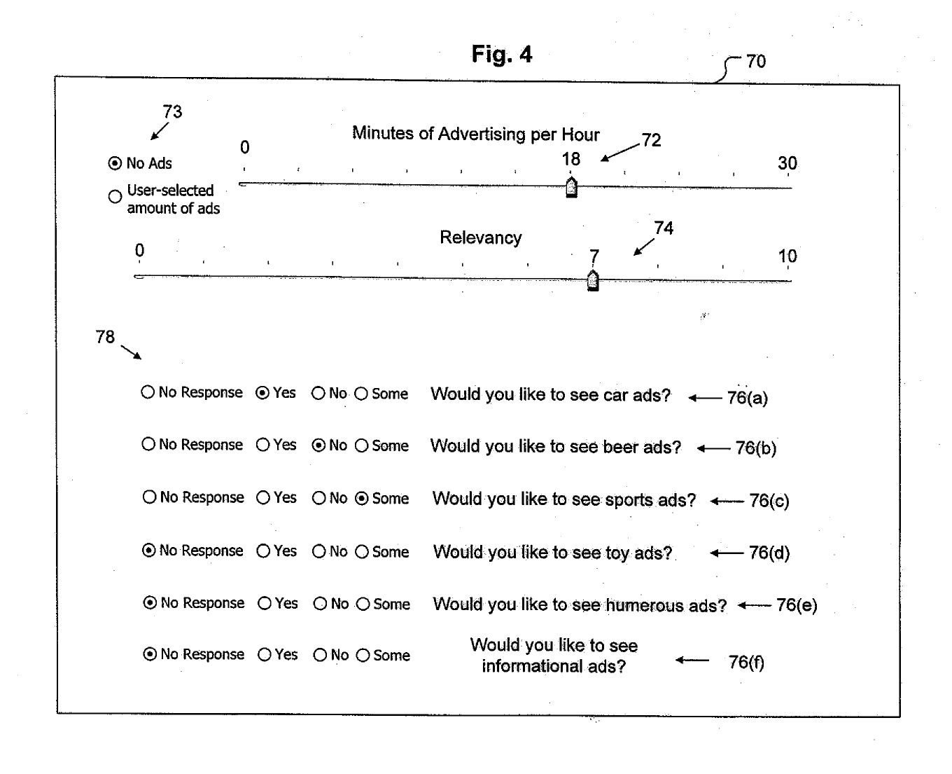

FIG. 4 depicts a graphical user interface (GUI) 70 to be displayed on the display device 32. The GUI 70 contains two slider controls 72, 74. One slider control 72 allows a viewer to choose an amount of advertising to be displayed per hour. As depicted, the viewer may select between 0 and 30 minutes of advertising per hour. The default setting of 18 minutes is currently selected. In an alternative embodiment the slider control 72 may instead control the number of banner advertisements 66 to be displayed on a web page 62. The GUI may also contains a set of radio buttons 73 that allows the viewer to select either completely advertising-free programming or an amount of advertising as defined by slider control 72.

The GUI may also contains a set of questions 76 about what kinds of advertisements the viewer wishes to see. Each question 76 is accompanied by a set of radio buttons 78 indicating the viewer's response. The default setting is “No response.” Additionally, the viewer may select “Yes,” “No,” or “Some.” For example, with respect to question 76(a), if the viewer indicates “Yes,” then the viewer has indicated a preference for seeing car advertisements. As an additional example, with respect to question 76(b), if the viewer indicates “No,” then the viewer has indicated a preference for NOT seeing beer advertisements. As an additional example, with respect to question 76(c), if the viewer indicates “Some,” then the viewer has indicated that some sports advertisements are desired, while other are not. In such a case, the GUI 70 may then proceed to present additional questions to the viewer. For example, the GUI 70 may ask if the viewer would like to see baseball ads, basketball ads, hockey ads, football ads, soccer ads, ads for non-traditional sports, and/or ads for sports fantasy camps. It should be understood that the specific questions 76 depicted in FIG. 4 and described above are examples only. Different questions about different advertising preferences may instead be asked.

The second slider 74 allows a user to choose a relevancy threshold setting for advertising provision. The viewer may select a relevancy threshold setting between 0 and 10. The default setting of 7 is currently selected. The relevancy threshold setting indicates how closely the viewer's preferences for specific types of advertising are to be followed. As is well-known in the art, a relevance score may be calculated for any particular advertisement (based on characteristics associated with the advertisement and the viewer's preferences). If such a score is calculated on a 10-point scale, then the relevancy threshold setting indicates that only advertisements with relevance scores exceeding the relevancy threshold setting are to be shown to the user. Thus a high relevancy threshold setting indicates that the viewer is not willing to tolerate any (or at most a few) advertisements of a type that the viewer has indicated a preference against seeing, while a low relevancy threshold setting indicates that the viewer is willing to tolerate more advertisements that the viewer has not confirmed interest in.

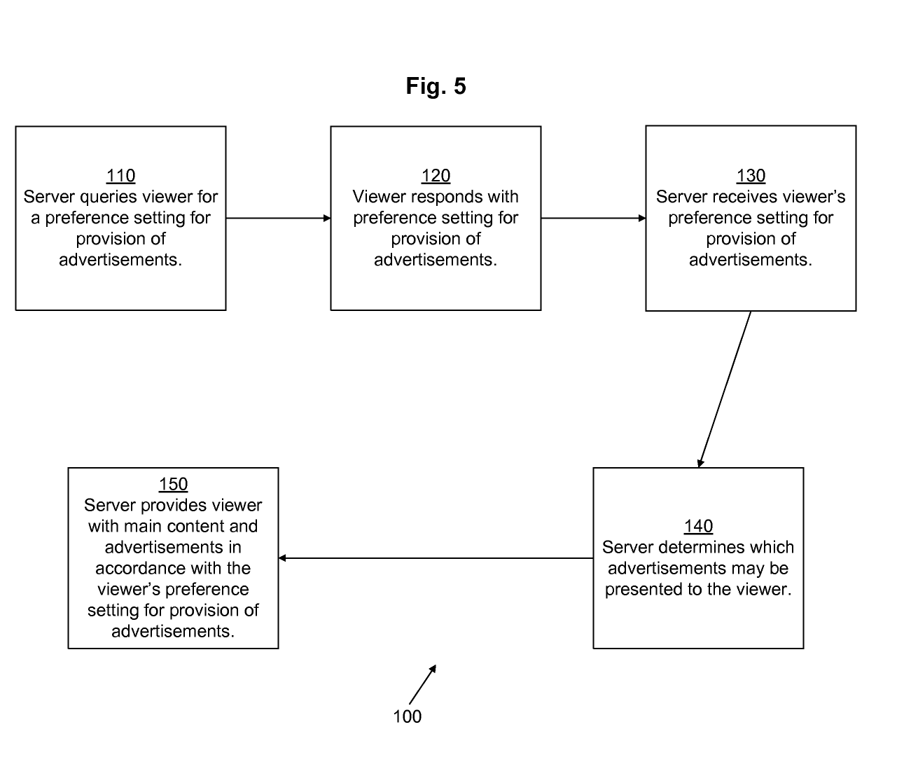

FIG. 5 depicts a method 100 which demonstrates one embodiment that may be performed using the system of FIG. 1. In step 110, the server 38 queries the viewer, typically via a GUI 70 as depicted above in FIG. 4, for a preference setting for provision of advertisements. In some embodiments, the terminal device 34 issues the queries rather than the server 38.

In step 120, the viewer responds to the query by selecting a preference setting for provision of advertisements. In one embodiment, this preference setting represents an amount of advertising to be shown per hour in a video program (or, alternatively, an amount of banner advertisements to be placed on a web page) as communicated, for example, by the first slider 72 and the set of radio buttons 73. In another embodiment this preference setting represents an amount of advertising to be shown prior to the viewer being permitted to view any main content, as for example on a web page.

In yet another embodiment, this preference setting is a relevancy threshold setting. In one embodiment, the relevancy threshold setting is used in conjunction with answers to questions 76 received by the GUI 70 via radio buttons 78. In another embodiment, the relevancy threshold setting is used in conjunction with other data received by the server 38 about the viewer's viewing habits, which allow the server 38 to determine how relevant certain advertisements may be.

In some embodiments, in exchange for the viewer selecting to view more advertisements, the viewer is provided with compensation. Similarly, in some embodiment, in exchange for the viewer selecting a lower relevancy threshold setting, the viewer is provided with compensation.

In one embodiment, the compensation is provided to the viewer by altering the viewer's subscription fee. For example, suppose a cable operator typically charges a subscriber $50 per month for cable VoD service. This is the subscription fee if the subscriber views the default 18 minutes per hour of advertisements. However, if the subscriber chooses to view 25 minutes per hour of advertisements, then the cable operator will only charge $30 per month. Alternatively, if the subscriber wishes to view only 10 minutes of advertisements per hour, the fee might increase to $70 per month. Or, if the viewer desires to see no advertisements at all, the fee might climb to $150 per month. Similarly, the $50 monthly fee assumes a relevancy threshold setting of, for example, 7. If the subscriber chooses a higher relevancy threshold setting, such as 9, then the fee might increase to $75 per month. Or, if the subscriber chooses a lower relevancy threshold setting, such as 4, then the fee might decrease to $25 per month.

In one embodiment, the viewer may change his or her responses to the queries on a temporary basis. Thus, while the viewer might ordinarily desire to see 18 minutes of advertising per hour for a standard $50 subscription fee, one evening the viewer might decide he or she would like to watch a movie commercial free. The fee for applying that viewer preference to one movie might be an additional $3 added to the monthly subscription fee. The user may similarly alter the relevancy threshold setting on a temporary basis.

In another embodiment, the compensation is provided to the viewer by providing the user with tradable credits. For example, a cable operator may charge $50 per month for standard VoD service, this service including the ability to watch 10 standard movies per month, plus 10 tradable credits per month. The viewer may trade a credit for the right to watch one additional standard movie. Or the viewer may trade two credits for the right to watch a “premium” movie (such as a new release). The user is able to earn additional credits for watching additional movies per month if the user agrees to watch additional advertisements. Thus, if the viewer chooses to view 25 minutes of advertising per hour instead of the default 18 minutes, then the cable operator may increase the number of credits provided to the viewer each month to 15 credits. Or, if the viewer chooses to view only 10 minutes of advertising per hour instead of the default 18 minutes, then the cable operator may decrease the number of credits provided to the viewer each month to 5 credits. If on one occasion, the viewer decides to watch a movie completely commercial-free, the cable operator may deduct 1 credit from the viewer's account. If on another occasion, the viewer decides to watch a movie with 30 minutes per hour of advertising, the cable operator may add 1 extra credit to the viewer's account. The user may similarly alter the relevancy threshold setting in order to receive tradable credits.

In step 130, the server 38 receives the viewer's answers.

In step 140, the server 38 determines which advertisements 42 may be presented to the viewer. In particular, this may be done by assigning to each advertisement 42 within the database 40 a score indicating how relevant each advertisement 42 is to the viewer. This assignment of score is well-known in the art, and it may be done by any method. The relevancy score may be calculated with respect to viewer responses to questions 76, or it may be calculated with respect to data mined from the viewer's computer or other data mined about the viewer's habits (for example, what kind of main content the viewer regularly views, what kinds of product the viewer buys online, etc.). The server then marks all advertisements 42 whose score equals or exceeds the relevancy threshold setting received from the user (from slider 74 of the GUI 70) as potential advertisements to display to the viewer, forming a pool of potential advertisements.

In step 150, the server sends main content to the viewer. In addition to the main content, the server also sends advertisements 42 from the pool of potential advertisements to the viewer.

In one embodiment, the main content is Video on Demand (VoD) content requested by the user. In such a case, the server 38 sends video advertisements to the viewer interspersed with the VoD content. The VoD content may have pre-assigned break-points during which advertisements may be inserted, or alternatively, break-points may be determined on the fly. In one embodiment, the number of break-points may depend on a user selection. In another embodiment, a break-point may occur upon the occurrence of a triggering event (such as, for example, the appearance on the screen of a particular actor). The amount of advertising displayed during each break-point depends on the number of minutes of advertising the user wishes to see per hour as selected in slider 72 of the GUI. The specific video advertisements presented are chosen from the pool of potential advertisements. This is typically done according to a provider-specific advertisement selection algorithm. This embodiment may be performed over a cable television network having VoD support. It may also be performed over a computer network, where the server 38 provides VoD video clips across the computer network to the viewer's computer for display in a window on the computer monitor.

In another embodiment, the main content is live television content (excluding the advertisements). Such live television content is broadcast from a television station and received by the server 38. In such a case, the server 38 forwards the live television content to the viewer, but sends video advertisements 56 to the viewer in place of the advertisements which are contained on the live television broadcast from the television station. In such a case, the server ignores the number of minutes of advertising the user wishes to see per hour as selected in slider 72 of the GUI (in some embodiments, the GUI 70 refrains from presenting slider 72 to the viewer at all). The specific video advertisements 56 presented are chosen from the pool of potential advertisements.

In another embodiment, the main content is the body of a web page. In such a case, the server 38 sends the web page to the viewer with embedded banner advertisements 66. The number of embedded banner advertisements 66 depends on the number of banner advertisements 66 the viewer wishes to see as selected in slider 72 of the GUI. The specific banner advertisements 66 presented are chosen from the pool of potential advertisements. This embodiment may be performed over a computer network 36, where the server 38 provides web pages across the computer network to the viewer's computer for display in a browser window 60 on the computer monitor.

In another embodiment, the main content may either be the body of a web page or it may be video content. Before the server 38 sends the main content to the viewer, however, an amount of advertising (pre-selected by the viewer) is displayed. In one embodiment, this advertising contains video advertisements displayed for a fixed amount of time. In another embodiment, this advertising contains advertisements displayed on a web page for a fixed amount of time. The amount of advertising shown depends on the number of amount of advertising the viewer wishes to see as selected in a slider of the GUI 70. The specific advertisements presented are chosen from the pool of potential advertisements.

In one embodiment, after a particular advertisement 42 is shown to the viewer, the viewer may decide that he or she does not wish to see that particular advertisement 42 again. In such a case, the viewer may click on the undesired advertisement 42 and send a response to the server 38 indicating not to play that advertisement 42 again. That advertisement 42 is then removed from the pool of potential advertisements.

In another embodiment, a viewer may fast-forward through the advertisement portion 56 of a video if the viewer does not wish to see that particular advertisement 42. In such a case, the server 38 may tag that particular advertisement 42 so as not to display that advertisement 42 to the viewer again. That advertisement 42 is then removed from the pool of potential advertisements. Alternatively, the advertisement 42 may only be removed after it has been fast-forwarded through several times, so as to increase confidence that the viewer does not want to see that advertisement 42.

Similarly, in other embodiments, a viewer may otherwise implicitly indicate that a particular advertisement 42 should not be shown again. For example, while watching live television, the viewer may change the channel or activate an Electronic Program Guide every time a particular advertisement 42 is shown. Once the channel is changed away from the particular undesired advertisement 42 (these channel changes may be additive with fast forwards as well) several times, that advertisement 42 is then removed from the pool of potential advertisements.

While various embodiments of the invention have been particularly shown and described, it will be understood by those skilled in the art that various changes in form and details may be made therein without departing from the spirit and scope of the invention as defined by the appended claims.

For example, embodiments were described as operating over a network. However, a network is not needed. The server could be an application residing on the terminal device. In such a case, the advertisements would be presented to the viewer without any need to transfer them over a network, and the queries and responses would be local as well.

As another example, server 38 was described as containing an advertisement database 40. However, the server 38 may not house the database 40—instead the database 40 may be stored on other computers connected to the same network 36.

What is claimed is:

1. A method comprising:
querying a viewer for a preference setting for provision of advertisements;
receiving from the viewer a response to the query for the preference setting for provision of advertisements;
providing to the viewer an electronic signal, the electronic signal including:
a first component having a main content portion; and
a second component having advertising in accordance with the response;
wherein the first component and the second component are distinct.

2. A method as in claim 1 wherein the preference setting for provision of advertisements is an amount of advertising to be presented per unit time and wherein:
providing to the viewer the electronic signal includes:
presenting to the viewer within the second component the amount of advertising in one unit of time.

3. A method as in claim 2, further comprising:
receiving from the viewer a variable fee, the amount of the fee varying inversely with the amount of advertising to be presented per unit time.

4. A method as in claim 2, further comprising:
providing the viewer with compensation for selecting a preference for a larger amount of advertising to be presented per unit time, the amount of the compensation varying with the amount of advertising to be presented per unit time.

5. A method as in claim 4 wherein providing the viewer with compensation includes reducing a fee paid by the viewer for subscription-based content services.

6. A method as in claim 4 wherein providing the viewer with compensation includes giving the viewer tradable credits, wherein giving the viewer tradable credits includes incrementing a digital credit counter in a user account assigned to the viewer, the digital credit counter storing a number of credits which the viewer may exchange for additional services.

7. A method as in claim 2 wherein providing to the viewer the electronic signal includes:
sending a digital video signal over a computer network, wherein:
the main content portion is viewer-selected video content;
the advertising includes video advertisements; and
the first component and the second component are to be played at different times.

8. A method as in claim 2 wherein providing to the viewer the electronic signal includes:
sending a video signal over a television cable system, wherein:
the main content portion is viewer-selected video content;
the advertising includes video advertisements; and
the first component and the second component are to be played at different times.

9. A method as in claim 1 wherein the preference setting for provision of advertisements is an amount of advertising to be presented before access is granted to main content, and wherein:
providing to the viewer the electronic signal includes:
providing within the second component the amount of advertising to be presented before access is granted to main content;
providing the first component to the viewer after the second component has been presented to the viewer.

10. A method as in claim 9, further comprising:
receiving from the viewer a variable fee, the amount of the fee varying inversely with the amount of advertising to be presented before access is granted to main content.

11. A method as in claim 2, further comprising:
providing the viewer with compensation for selecting a preference for a larger amount of advertising to be presented before access is granted to main content, the amount of the compensation varying with the amount of advertising to be presented before access is granted to main content.

12. A method as in claim 1 wherein:
the preference setting for provision of advertisements is a relevancy threshold setting;
the method further comprises receiving from the viewer a set of preferences for advertisements of certain types; and
providing to the viewer the electronic signal includes:
presenting to the viewer within the second component advertisements (a) that closely match the received set of preferences for advertisements of certain types when the relevancy threshold setting is low and (b) that less closely match the received set of preferences for advertisements of certain types when the relevancy threshold setting is high.

13. A method as in claim 12, further comprising:
receiving from the viewer a variable fee, the amount of the fee varying with the relevancy threshold setting.

14. A method as in claim 12, further comprising:
providing the viewer with compensation for selecting a lower relevancy threshold setting, the amount of the compensation varying with the relevancy threshold setting.

15. A method as in claim 14 wherein providing the viewer with compensation includes reducing a fee paid by the viewer for subscription-based content services.

16. A method as in claim 12 wherein receiving from the viewer the set of preferences for advertisements of certain types includes receiving from the viewer a list of classes of advertisement types that the user wishes to see.

17. A method as in claim 12 wherein:
receiving from the viewer the set of preferences for advertisements of certain types includes receiving an indication as to which specific advertisements the viewer does not wish to see; and
providing to the viewer the electronic signal includes:
refraining from providing to the viewer the specific advertisements the viewer does not wish to see; and
in place of the advertisements the viewer does not wish to see, providing to the viewer other advertisements.

18. A method as in claim 12 wherein receiving from the viewer the set of preferences for advertisements of certain types includes receiving data about the viewer's viewing habits.

19. A method as in claim 1 wherein providing to the viewer the electronic signal further includes:
sending a video signal over a live television system, wherein:
the main content portion is live television content;
the advertising includes pre-recorded video advertisements; and
the first component and the second component are to be played at different times.

20. A method as in claim 1 wherein providing to the viewer the electronic signal includes:
sending a digital video signal over a computer network, wherein:
the main content portion is viewer-selected video content;
the advertising includes video advertisements; and
the first component and the second component are to be played at different times.

21. A method as in claim 1 wherein providing to the viewer the electronic signal includes:
sending a video signal over a television-based video-on-demand system, wherein:
the main content portion is viewer-selected video content;
the advertising includes video advertisements; and
the first component and the second component are to be played at different times.

22. A method as in claim 1 wherein providing to the viewer the electronic signal includes:
sending a web page over a computer network, wherein:
the main content portion is the body of a web page having viewer-selected content;
the advertising includes banner advertisements; and
the first component and the second component occupy different portions of the web page.

23. Software encoded in one or more computer-readable media and when executed operable to:
present a graphical user interface (GUI) to a viewer on a video screen, the GUI presenting to the viewer a slider control, the slider control allowing the viewer to choose a preference setting for provision of advertisements;
receive from the viewer the preference setting for provision of advertisements;
provide to the viewer an electronic signal, the electronic signal including:
a first component having a main content portion; and
a second component having advertising in accordance with the received preference setting for provision of advertisements;
wherein the first component and the second component are distinct.

24. An apparatus comprising:
memory;
a network interface;
a controller, the controller being configured to:
query a user, over the network interface, for a preference setting for provision of advertisements;
receive from the user, over the network interface, a response to the query for the preference setting for provision of advertisements;
provide to the user, over the network interface, an electronic signal, the electronic signal including:
a first component having a main content portion; and
a second component having advertising in accordance with the response;
wherein the first component and the second component are distinct.
